(19) United States
(12) Patent Application Publication
(10) Pub. No.: US 2022/0122077 A1
(43) Pub. Date: Apr. 21, 2022

(54) MULTI-TRIGGER REAL-TIME APPEND-ONLY CREDITING ENGINE

(71) Applicant: Xactly Corporation, San Jose, CA (US)

(72) Inventor: Saravanabavagugan Vengadasundaram, San Jose, CA (US)

(21) Appl. No.: 17/107,712

(22) Filed: Nov. 30, 2020

(30) Foreign Application Priority Data
Oct. 16, 2020 (IN) 202011045079

(51) Int. Cl. G06Q 20/40; G06Q 40/02; G06Q 30/02; G06Q 30/08; G06Q 20/38; G06Q 10/10; G06F 16/23; G06F 21/64

(52) U.S. Cl. CPC G06Q 20/405; G06Q 40/025; G06Q 30/0226; G06Q 30/0215; G06Q 30/08; G06Q 20/389; G06Q 2220/00; G06Q 30/0235; G06Q 20/3829; G06Q 10/1053; G06F 16/2379; G06F 21/64; G06Q 20/4037

(57) ABSTRACT

A computer method of calculating credit values in incentive-based compensation comprises creating and digitally storing, in an electronic digital data store, credit rule records comprising expressions for calculating credit values, person assignment records that associate credit rule records with person records, and order records; receiving a request to execute a change of a credit rule, person assignment, or order; in real time in response, executing instructions to evaluate the credit rule against all orders then currently stored in the data store to determine a result set of matching orders, and append in the data store one or more credit value records each comprising a credit value, each credit value being calculated based on a rule expression, each credit value record being linked to an order identifier of matching orders, person assignment, and credit rule. Credit value records are always appended in the data store and not deleted or updated.

### BENEFIT CLAIM

This application claims the benefit under 35 U.S.C. 119 of India patent application 202011045079, filed Oct. 16, 2020, the entire contents of which are hereby incorporated by reference for all purposes as if fully set forth herein.

### TECHNICAL FIELD

One technical field of the present disclosure is distributed database systems. Another technical field is computer-implemented techniques for calculating values of credits attributable to hierarchical taxonomies of personnel in a multi-level organization.

### BACKGROUND

The approaches described in this section could be pursued but are not necessarily approaches that have been previously conceived or pursued. Therefore, unless otherwise indicated herein, the approaches described in this section are not prior art to the claims in this application and are not admitted to be prior art by inclusion in this section.

Certain business enterprises conduct sales activities via sales representatives who are organized in hierarchical taxonomies having multiple tiers or levels and complex relationships and rules to determine who is credited with what portion of a particular sale or sales. Crediting is the process of determining which sales representatives, among a large staff of representatives in the enterprise, are responsible for specific orders that the enterprise receives over time. In an enterprise having a hierarchical taxonomy of sales representatives, credits associated with representatives will determine the salary, bonus, or other compensation earned by and payable to the representatives. Because of the importance of compensation to most working people, correct calculation of credits is an essential business function. Digital electronic computers are used to execute calculation of credits.

Some enterprises may receive many bulk orders or orders in large quantities and may credit portions of those orders to different persons using predefined rules. Each rule is expressed in a symbolic language, or a set of digital objects and operators, which are defined using software tools and digitally stored in computer memory. Each rule is retrieved and executes against stored digital data to result in output records that can be used as a basis of determining compensation to individuals. Each programmed rule could be based on a combination of many attributes such as product, region, sales channel, or other characteristics. The number of rules varies based on the organization; some enterprises may program thousands of rules. For example, instances are known in which enterprises receive millions of orders per month and have thousands of rules that must be applied to calculate compensation credits.

Traditionally, credits are calculated using brute-force, batch processing methods, in which all the crediting rules are applied to all orders. In these methods, a batch or set of crediting rules is applied using a computer-implemented process to all orders that have been received in a specified time period. As the number of rules increases, the number of required calculations increases on a quadratic basis, which does not scale. At some point, with a large enough set of rules and a large enough set of orders, the amount of time required to calculate all credits with available computing hardware at reasonable cost will be excessive. Therefore, an improved methodology to compute credits is needed so that it can be achieved at large scale without compromising consistency or correctness.

### SUMMARY OF THE INVENTION

The appended claims may serve as a summary of the invention.

### BRIEF DESCRIPTION OF THE DRAWINGS

In the drawings:

FIG. 1A illustrates an example network of distributed computers that can form one environment or context for an embodiment.

FIG. 1B also illustrates an example of the flow of programmatic calls in a distributed computer system starting with a call to an application programming interface (API) and terminating with one or more updates to a digital data store.

FIG. 2 is an entity relationship diagram illustrating data entities that may be programmed in one embodiment.

FIG. 3 illustrates a rule change processor, assignment change processor, and order change processor with stored program instructions to process create, modify, and delete events.

FIG. 4 illustrates an example computer system with which an embodiment may be implemented.

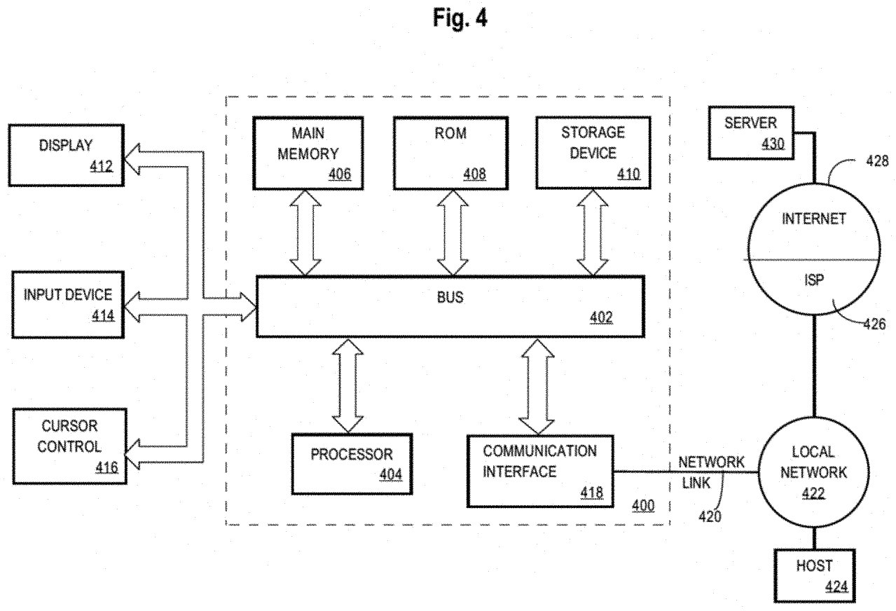

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### 1. GENERAL OVERVIEW

A computer-implemented, multi-trigger real-time crediting calculation method is described. Embodiments avoid updating or deleting existing data, but instead only append new credit value records to a data store as credit values are calculated in real-time in response to triggering events such as changes in rules, changes in person assignments, and changes in orders. If an order changes, then only the difference in credit value is calculated and appended. By responding to changes as they occur and not using a batch approach, and by using append-only data store operations that can be aggregated or consolidated if needed, vastly greater throughput is achieved, and the bottlenecks described in the background are avoided.

In an embodiment, a computer-implemented method of calculating credit values in incentive-based compensation systems and updating a data store of digitally stored credit values comprises: creating and digitally storing, in an electronic digital data store, a plurality of credit rule records comprising rule expressions for calculating credit values, a plurality of person assignment records that associate credit rule records with person records, and a plurality of order records, the order records each comprising an association of an order identifier with at least an order amount; receiving a request to execute a change of a credit rule, person assignment, or order; in real time in response to the request, executing stored program instructions that are programmed to, in response to a request to execute the change of the credit rule: evaluate the credit rule against all orders then currently stored in the data store to determine a result set of matching orders, and digitally append in the data store one or more credit value records each comprising a credit value, each credit value being calculated based on a rule expression of the credit rule, each credit value record being digitally linked to an order identifier of one of the matching orders, to the person assignment, and to the credit rule; repeating the receiving and executing steps, in which execution of the evaluate and determine step always causes to digitally append the one or more credit value records in the data store and not to delete credit value records in the data store and not to update existing credit value records in the data store.

In one feature, a computer-implemented method further comprises, in real time in response to the request, executing stored program instructions that are programmed to, in response to a request to execute the change of the order: evaluate the order against all credit rules then currently stored in the data store, determine a result set of matching credit rules, and digitally append in the data store a credit value record comprising a credit value that is calculated based on a rule expression of the credit rule, and that is linked to the order identifier, the person assignment, and the credit rule.

In one feature, a computer-implemented method further comprises calculating the credit value of a particular matched credit rule by evaluating the rule expression and digitally applying a split percent value of each person assignment having a rule identifier that matches the particular matched credit rule.

In one feature, a computer-implemented method further comprises the request comprising an incentive date value, and: filtering the credit rules that are stored in the data store to include only credit rules having an effective start date and effective end date indicating validity as of the incentive date value, to yield a set of filtered credit rules; performing a lookup of credit value records in the data store that match the filtered credit rules, to yield a set of selected credit value records; evaluating the order against the filtered credit rules then currently stored in the data store, determine a result set of matching credit rules, and calculate one or more new credit values based on applying the order to rule expressions of the filtered credit rules; digitally appending in the data store one or more new credit value records each comprising a credit value that is calculated based on a difference in credit values of the selected credit value records in comparison to the new credit values.

In one feature, a computer-implemented method further comprises, in real time in response to the request, executing stored program instructions that are programmed to, in response to a request to execute a deletion of a particular credit rule, create and append one or more compensating credit value records in the data store, each of the compensating credit value records having a negative value equal to a sum of all credit values that had been appended prior to the request and linked to the particular credit rule.

The method may further comprise receiving a request to display an aggregated credit value for a specified set of events or a specified period of time and, in real time in response to the request, calculating a sum of all credit values including compensating credit value records with negative credit values, and outputting the sum as an aggregated value.

The method may further comprise, in real time in response to a request to delete a particular person assignment, executing stored program instructions that are programmed to create and append a compensating credit value record in the data store, the compensating credit value record comprising a compensating negative credit value, the compensating negative credit value being equal to a sum of all credit values then currently existing in the data store that are linked to the particular person assignment.

The method may further comprise, in real time in response to a request to delete a particular order, executing stored program instructions that are programmed to create and append a compensating credit value record in the data store, the compensating credit value record comprising a compensating negative credit value, the compensating negative credit value being equal to a sum of all credit values then currently existing in the data store that are linked to the particular order.

### 2. STRUCTURAL & FUNCTIONAL OVERVIEW

A real-time crediting engine is disclosed having multiple triggering events and using an indexed, distributed database which can execute write operations at high speed. By “real-time,” this disclosure means that the algorithms, computing processes and calculations described herein will execute immediately in response to an API call, request, or other programmatic update to a crediting rule, person assignment, or order. Unlike prior approaches in which non real-time, batch processing is used, the algorithms, computing processes and calculations described herein execute as a continuing process to make continuing updates to a data store of credit data.

Furthermore, unlike past approaches, a calculation of a credit value, the application of rule expressions to orders or person assignments, and other operations may execute asynchronously. The API calls, requests, or other messages may have a plurality of different types such as create, update, delete, and may relate to rules, person assignments, and orders; thus, at least nine (9) kinds of trigger events, conditions, or entities are contemplated, and any such trigger may cause a real-time, immediate append operation to the data store. Consequently, credit values are updated continuously and immediately in response to a trigger so that the data store is continuously available to query for then-current sums or aggregations of credit values.

In an embodiment, key information of trigger entities that caused a credit to be generated is associated with the credit data using digital storage in the database. Whenever a change occurs on the trigger entity, the change can be broadcasted as an event with the change information along with the keys as part of the event message. An event processor is programmed to check if the key corresponding to the trigger entity has any credits already generated. If yes, then credits with the difference amount based on the change can be generated to tally for the current state of the credit.

Implementing the algorithms, computing processes and calculations described herein only uses add operations or append operations with the data store; update and delete operations are not required. The exclusive use of append operations has been discovered to substantially increase throughput and response time by eliminating update or delete operations which are more expensive because of index update overhead, locking overhead or simply to ensure consistency depending on the database technology being used.

A separate processing job can execute aggregation of a plurality of appended credit data records. A result of such aggregation expresses or reflects the complete state of the credits.

Additionally, or alternatively, the aggregation results can be written to another tablespace to result in compacting and greater efficiency later. Thus, the aggregation approach allows a new credit value to be created from the aggregated values and stored in a separate tablespace or the same tablespace, thereby reducing the total amount of credits to be processed for incentive calculation.

The disclosed approaches also enable the state of credits to be viewed at a specific past point in time.

2.2 Example Network Architecture

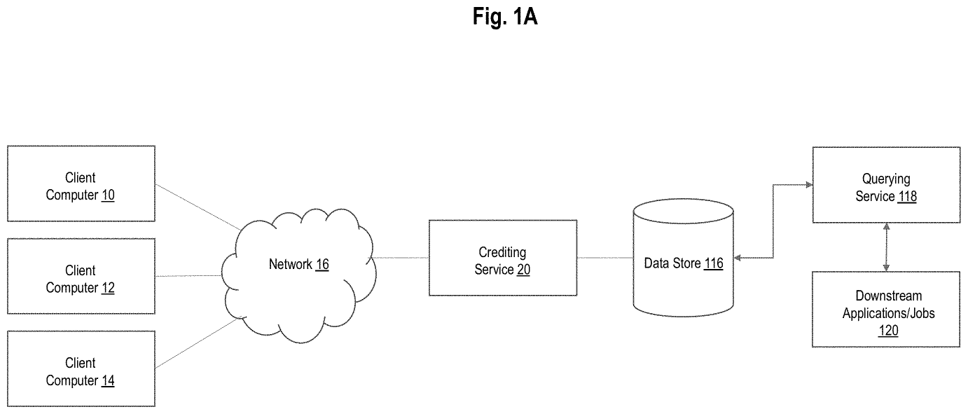

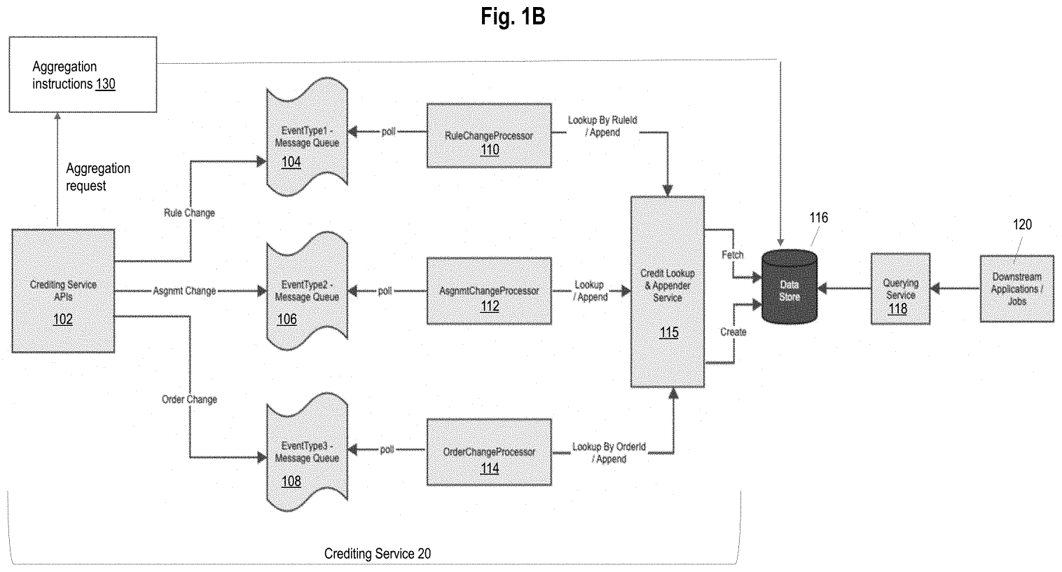

FIG. 1A illustrates an example network of distributed computers that can form one environment or context for an embodiment. FIG. 1B illustrates an example of the flow of programmatic calls in a distributed computer system starting with a call to an application programming interface (API) and terminating with one or more updates to a digital data store.

Referring first to FIG. 1A, in an embodiment, a plurality of client computers 10, 12, 14 are communicatively coupled directly or indirectly via one or more networks 16 to a crediting service 20. Network 16 broadly represents one or more network cables, local area networks, wide area networks, campus networks, and/or internetworks using any of terrestrial or satellite links, wired or wireless links, to communicate digital electronic data between the functional elements using known network communication protocols such as IP, TCP, and HTTPs. Lines in FIG. 1A indicate communication links that use one or more cables, wires, networks, or internetworks to communicate data, programmatic calls, or other messages between the functional elements.

The crediting service interoperates with a data store 116, which is communicatively coupled to a querying service 118. Data store 116 may comprise a relational database, No-SQL database, object database, set of flat files, or other electronic digital data repository in combination with database access, indexing, and management software. The data store 116 is programmed to receive and respond to queries and to append data. The data store 116 may allow other operations such as update or delete operations, but in an embodiment, the data store is selected to provide maximum performance for append operations. Some embodiments may use a database that only supports lookup and append operations.

The querying service 118 is programmed to generate and submit queries to the data store 116 for the purpose of retrieving result sets of credit values 240, or details of credit rules 202, person assignments 210, orders 220, credit value records 230, and person records 250. One or more downstream applications or jobs 120 may be communicatively coupled to the querying service 118. With the use of network links as shown in FIG. 1A, FIG. 1B, the computing elements in these illustrations are capable of virtually instantaneous communication with other elements using programmatic calls, requests, and messages that are communicated over the links using network protocols.

Any number of client computers 10, 12, 14 may be used in various implementations and three such elements are shown solely to illustrate one clear example without limiting other embodiments. Each of the client computers 10, 12, 14 comprises any of a personal computer, workstation, laptop computer, mobile computing device or, in some embodiments, a process executing on a computer that transmits calls into network 16 toward crediting service 20. Crediting service 20, data store 116, querying service 118, and applications 120 may be implemented using one or more computers, storage devices or other hardware elements and single elements are shown solely to illustrate one clear example without limiting other embodiments.

In one embodiment, each of the client computers 10, 12, 14 is associated with or managed by a first entity, such as an operating company, and all other elements of FIG. 1A are associated with or managed by a second entity that operates as a service provider to the operating company. For example, crediting service 20 and data store 118 may be implemented as SaaS using computers or processing elements in a private data center, public data center or cloud computing facility. Querying service 118 and applications 120 may be implemented in the same data center or facility, or different facilities.

In operation, in general, one or more of the client computers 10, 12, 14 transmits programmatic calls that conform to the definition of an application programming interface (API) and specify API endpoints implemented in stored programs executing at the crediting service 20. Such API calls are carried via network messages from the client computers across network 16 to the API endpoints at crediting service 20. The crediting service 20 is programmed to buffer, parse, and execute the API calls using processors or program subroutines or methods that are tailored to particular API calls. As a result, crediting service 20 executes credit lookup operations, credit calculation operations, and credit appending operations using relational tables that have been previously defined and opened in data store 116.

Inbound API calls can be received from client computers 10, 12, 14, applications running on the client computers, and/or any of a variety of other external programs, computers or services. For example, client computers 10, 12, 14 may execute local applications that are programmed to support creating, updating, or deleting digitally stored credit rules, orders, and assignments of persons to credit rules. Examples include custom rule defining programs, ERP systems, e-procurement systems and so forth. These applications may be programmed to call the crediting service 20 using API calls that conform to the API defined by the crediting service. When the client computers 10, 12, 14, applications, or other systems issue API calls, the crediting service 20 is programmed, as further described, to respond immediately to each such call on a real-time basis, rather than batching up requests or calls and processing them as a group later. “Real-time,” in this context, refers to executing a programmed action as soon as practicable after a call, request or message is received, without any programmed wait state, delay, or batching. Depending on the hardware and software used for programming, an implementation may cause real-time processing on a nearly instantaneous basis, or with delays of microseconds to seconds.

Asynchronously in relation to the crediting service 20, the querying service 118 may transmit programmatic queries conforming to Structured Query Language (SQL), non-SQL query languages, or other query protocols to the data store 116. In one embodiment, data store 116 uses a technology that is optimized for fast append operations, possibly as a tradeoff against other performance attributes. In response, data store 116 is programmed to search the data tables or other stored datasets in the data store, form a result set of responsive data, and transmit the responsive data to the querying service 118. In an embodiment, data store 116 comprises a processor that is independent of the crediting service and can receive and respond to queries from the querying service 118 without affecting or interrupting operations of the crediting system 20.

In some embodiments, the querying service 118 may transmit results sets to downstream applications/jobs 120. Furthermore, in an embodiment, the querying service 118 may be programmed to receive programmatic requests for credit data from the downstream applications/jobs 120 and, acting as a proxy for the downstream applications/jobs 120, formulate queries to the data store 116, transmit the queries, receive result sets and forward the result sets to the downstream applications/jobs 120.

Referring now to FIG. 1B, in an embodiment, the crediting service 20 comprises crediting service APIs 102 that are communicatively coupled to network interfaces and receive programmatic calls to APIs that the crediting service defines. APIs 102 may comprise one or more stored program methods, routines or objects that are programmed to receive an incoming programmatic request, such as a parameterized HTTP URL or HTTP payload comprising a JSON object, to parse the payload or request, determine a type of the request, and forward all or a portion of the request to a selected message queue from among a plurality of message queues.

In one embodiment, APIs 102 are coupled to three (3) message queues 104, 106, 108, each of which is associated with a different type of crediting event that a request may represent. In one embodiment, the message queues are associated with rule change events, assignment change events, or order change events. The inventors have discovered, in an inventive moment, that these three (3) event types are the minimum and maximum required to implement a practical embodiment of a crediting system, but other embodiments may implement other types of events. The message queues 104, 106, 108 are programmed as first-in, first-out queues of arbitrary size. When APIs 102 receive a call, request, or message, the APIs are programmed to determine the type of call, request, or message, and to queue the call, request or message to one of the message queues 104, 106, 108, based upon the type, on a real-time basis without programmed delay or batching.

In an embodiment, each message queue is coupled to a respective processor that is programmed to execute substantive operations concerning the type of event which is queued into the message queue. In one embodiment, a first message queue 104 is coupled to a rule change processor 110, a second message queue 106 is coupled to an assignment change processor 112, and a third message queue 108 is coupled to an order change processor 114. In an embodiment, each processor 110, 112, 114 is programmed to periodically poll the message queue 104, 106, 108 to which it is coupled and obtain the next available message for processing. In an embodiment, polling occurs continuously so that messages are dequeued and processed on a real-time basis without programmed delay or batching and subject only to the throughput of the processors 110, 112, 114.

In an embodiment, the rule change processor 110 is programmed to execute a lookup operation based upon a rule identifier value and to programmatically request a credit lookup and appender service 115 to append a record to the data store 116. In an embodiment, the assignment change processor 112 is programmed to execute a lookup operation and to programmatically request the credit lookup and appender service 115 to append a record to the data store 116. In an embodiment, the order change processor 110 is programmed to execute a lookup operation based upon an order identifier value and to programmatically request the credit lookup and appender service 115 to append a record to the data store 116. A detailed description of algorithms to execute these operations appears in other sections herein.

The credit lookup and appender service 115 is programmatically coupled to each processor 110, 112, 114 and to the data store 116, and is programmed to execute fetch operations or create operations on the data store. Notably, the system of FIG. 1A, FIG. 1B is programmed exclusively to execute fetch and query, or read and append, operations on the data store 116. An update operation for an existing record is not defined and is not required. Instead, as further described herein, successive append operations are sufficient and an aggregation process may be used to yield a result value that is the net of successive append operations.

In an embodiment, APIs 102 are coupled to aggregation processor 130, which are programmed to implement the aggregation or consolidation functions that are described further in other sections hereof. The APIs 102 may programmatically call the aggregation processor 130 in response to receiving an API call specifying an aggregation operation or request. For example, aggregation processor 130 may be programmed to submit a search query specifying one or more filter values or patterns to data store 116, receive a result set of credit value records in return, calculate a summation of credit values represented in the result set to accomplish an aggregation or roll-up of a plurality of credit values that are associated with the same order, rule, or person assignment, and output the aggregation in a graphical user interface display, notification, or response to an API call. In some embodiments, aggregation processor 130 is programmed to pause the credit lookup and appender service 115 to serve a stable state of data across all consumers.

For purposes of the appended claims, each element of FIG. 1A, FIG. 1B having a reference numeral represents a computer associated with an entity, rather than the entity itself. For example, RuleChangeProcessor 110 is a computer, or a computer-implemented process, associated with an entity for calculating credits, not the entity itself. Thus, all elements of FIG. 1A, FIG. 1B are technical elements and none represents a person or entity. Each computer may be any of a server computer, a virtual computing instance hosted in a public or private data center or cloud computing service, a mobile computing device, personal computer or other computer as appropriate to the associated entity and functional purpose.

2.2 Example Data Entities

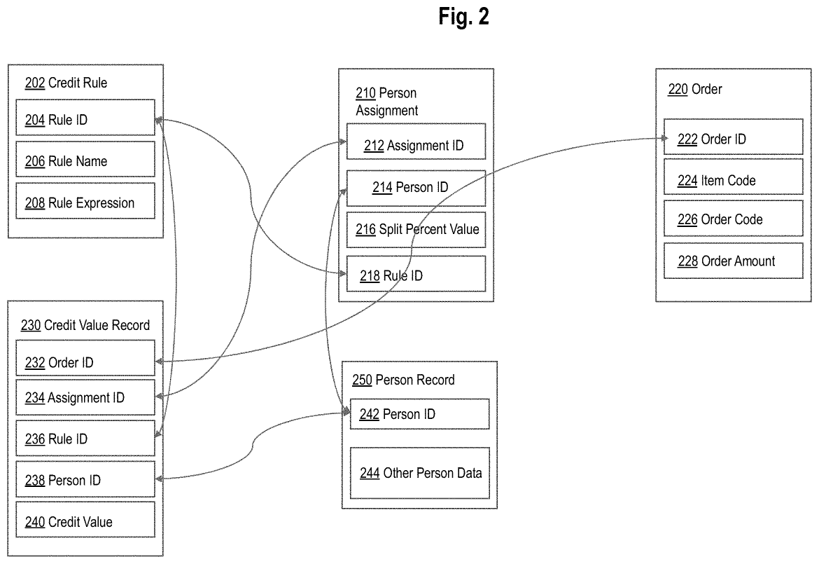

In an embodiment, data store 116 is programmed to store, query and manage a plurality of relational tables using four (4) principal data entities. FIG. 2 is an entity relationship diagram illustrating data entities that may be programmed in one embodiment. In one embodiment, tables in data store 116 may comprise credit rules 202, person assignments 210, orders 220, credit value records 230, and person records 250. The credit rules 202, person assignments 210, orders 220, credit value records 230, and person records 250 alternatively may be termed objects, rows, records, or values, depending on the technology used to implement the data store 116; in all cases, digitally stored elements are used. Therefore, for example, the following terminology may be used for the foregoing entities: credit rule records, person assignment records, order records, credit value records, and person records. In some embodiments, tables comprising rows of one or more of the foregoing entities may be managed in systems independent of the elements shown in FIG. 1A, FIG. 1B. For example, person records 250 may be maintained in a human resources database or HR system that is separate from the crediting service 20 and obtained using calls or other requests.

In FIG. 2, lines that join attributes of data entities represent digital links between attributes. Digital links may be implemented using programmatic constructs that are available in a particular source programming language and the data structures that it supports to implement the functional entities that are further described herein. Examples of digital links include pointers, addresses, or other references or programmatic constructs by which computers can read a particular attribute and fetch a linked or referenced record.

In an embodiment, each credit rule 202 comprises a digitally stored association of values for a rule identifier 204, a rule name 206, and a rule expression 208. In an embodiment, for a particular credit rule 202, the rule identifier 204 is a unique identifier for that particular rule. The rule name 206 is a string value comprising a human-readable name for the rule specified by the unique identifier. The rule expression 208 states the substance of a programmatic rule. In one embodiment, rule expression conforms to SQL WHERE clause grammar and can be evaluated using a stack-based parser. In other embodiments, each rule expression conforms to regular expression (regex) syntax, rules capable of evaluation using the Rete algorithm, or other expression protocols that are machine-executable.

In an embodiment, each person assignment 210 comprises a digitally stored association of values for an assignment identifier (“ID”) 212, person ID 214, split percent value 216, and rule ID 218. In an embodiment, for a particular person assignment 210, the assignment ID 212 is a unique identifier of that particular person assignment in the system. The person ID 214 is a value that uniquely references a person record 250 representing a particular person, such as a sales representative of an enterprise that uses percentage incentive compensation. The split percent value 216 is the particular portion of a credit, otherwise known as a split or percentage of a credit, that is assigned to the specified person as part of the particular person assignment for orders that match the linked rule. The rule ID 218 references one of the rule identifiers 204 of a credit rule 202 that constitutes the basis by which the split percent value 216 was determined. Each credit rule 202 could be linked to any number of person assignments.

In an embodiment, each order 220 comprises an order ID 222, item code 224, order code 226, and order amount 228. In an embodiment, for a particular order 220, the order ID 222 comprises a unique identifier of an order. The item code 224 specifies an item in the order. The order code 226 specifies a type of order. The order amount 228 specifies an amount represented in the order. The entity attributes that are shown for order 220 represent one possible example; other embodiments may define an order in more complex terms including more elements of line item detail, order terms, discounts, and so forth.

In an embodiment, each credit value record 230 comprises a digitally stored association of values representing an order ID 232, assignment ID 234, rule ID 236, person ID 238, and credit value 240. In an embodiment, for a particular credit value record 230, the order ID 232 references one of the order ID 222 values of an order 220. The assignment ID 234 references one of the assignment ID 212 values of a person assignment 202. The rule ID 236 references one of the credit rules 202. The person ID 238 references a person record 250. The credit value 240 is a calculated value of a credit that is associated with the specified order, assignment, rule, and person. Thus, in the system of this disclosure, each credit rule 202, person assignment 210, and order 220 represents input to a credit calculation and each credit value record 230 is created and appended to the data store 116 to represent the results of a credit calculation.

In an embodiment, a single credit rule 202 can reference and be associated with more than a single person assignment 210.

The number of instances of entities, and the values of entities, shown in FIG. 2 will change constantly during a credit calculation period. For example, the credit rule 202 and person assignments 210 can change every incentive period based on stored configuration data that reflects the requirements of an enterprise. Example incentive periods include monthly, quarterly, yearly. Order entities 220 may change during an incentive period; for example, a particular order could be originally entered, then updated as an ultimate customer requests changes to items, quantities or pricing before the order is finalized and placed. The credit value 240 may represent a split percentage value 216, or a function of the split percent and an order amount 228.

2.3 Event Processing Functions

Referring again to FIG. 1B, and FIG. 2, in an embodiment, the first message queue 104 and rule change processor 110 are programmed to queue and dequeue messages, and execute changes for credit rules 202; the second message queue 106 and the assignment change processor 112 are programmed to queue and dequeue messages, and execute changes for person assignments 210; and the third message queue 108 and the order change processor 114 are programmed to queue and dequeue messages, and execute changes for orders 220. Furthermore, in an embodiment, for each of the credit rules 202, person assignment 210, and orders 220, crediting service 20 is programmed to process three (3) event types denoted create, modify, and delete. Thus, the crediting service 20 may be programmed to process nine (9) distinct events. In some embodiments, the message queues 104, 106, 108 and processors 110, 112, 114 implement a publish-subscribe model in which the processors subscribe to events of interest and all events are published to the queues.

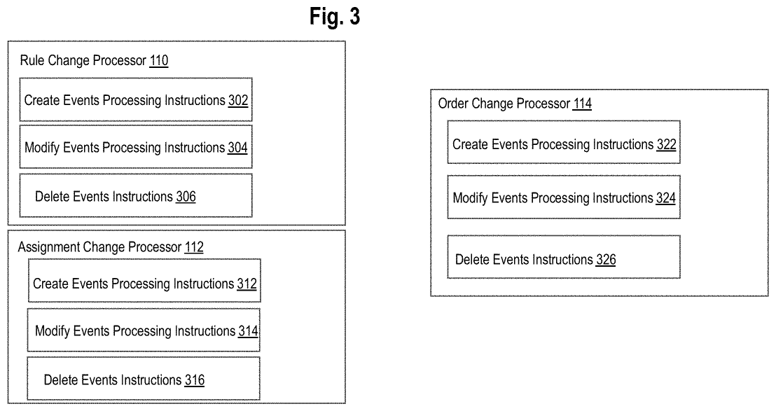

In an embodiment, a set of processing instructions is programmed for each of the event types. FIG. 3 illustrates a rule change processor, assignment change processor, and order change processor with stored program instructions to process create, modify, and delete events. In one embodiment, rule change processor 110 executes create events processing instructions 302, modify events processing instructions 304, and delete events instructions 306. The assignment change processor 112 executes create events processing instructions 312, modify events processing instructions 314, and delete events instructions 316. The order change processor 114 executes create events processing instructions 322, modify events processing instructions 324, and delete events instructions 326.

In an embodiment, the create events processing instructions 302, 312, 322 execute similar operations for rule change events, assignment change events, and order change events, respectively, to perform creation of data. In an embodiment, the modify events processing instructions 304, 314, 324 execute similar operations for rule change events, assignment change events, and order change events, respectively, to perform modification of data. In an embodiment, the delete events processing instructions 306, 316, 326 execute similar operations for rule change events, assignment change events, and order change events, respectively, to perform deletion of data.

Create Events Processing Instructions

In an embodiment, the create events processing instructions 302, 312, 322 execute according to the following algorithm.

Initially no entities exist in the system. Assume that an administrator logs in and creates a credit rule 202, for example, using a graphical user interface executing according to other instructions of the crediting service 20, or by using an external system to create the rule and transmit an API call for a create rule operation to APIs 102. Crediting service 20 is programmed, in response, for APIs 102 to generate an event of type CREATE RULE, which is queued to the first message queue 104. The consumer for that event type, such as rule change processor 110, evaluates the rule against all orders 220 in the data store 116. The create events processing instructions 302 may be programmed to implement this logic. Credits are not created for the orders 220 being matched because there are no orders in the system.

Asynchronously, an administrator creates one or more person assignments 210 for the credit rule 202 that was last created. Crediting service 20 is programmed, in response, for APIs 102 to generate an event of type CREATE ASSIGNMENT, which is queued to the second message queue 106. The consumer for that event type, such as assignment change processor 112, is programmed to query the data store 116 to retrieve the credit value records 230 matching the rule ID 218 with which the person assignment 210 is associated. The query would return a result set of null, because no credit value records 230 have been generated or stored in data store 116.

Assume that, asynchronously, another administrator creates an order 220. In response, crediting service 20 is programmed to generate an event of type ORDER_CREATE, which is queued to the third message queue 108. The consumer for this event, such as order change processor 114, is programmed to evaluate the incoming order against all credit rules 202 and person assignments 210 stored in data store 116.

For each matching credit rule 202, the rule expression 208 is evaluated against the order 220 and matching person assignments 210, to result in creating and appending one or more credit value records 230. Each credit value record 230 is populated with values for an order ID 232 obtained from order ID 222 of the incoming order 220, an assignment ID 234 matching the assignment ID 212 of a matching person assignment 210, a rule ID 238 corresponding to a rule ID 204 of a matching credit rule 202, and a person ID 238 matching the person ID 214 of the matched person assignment. The specific credit value 240 is calculated by evaluating the rule expression 208 and considering the split percent value 218 of each person assignment having a rule ID 218 that matches the credit rule 202. Specific techniques for evaluating rule expressions and split percent values, and calculating resulting credit values, are outside the scope of this disclosure.

If there is no match of the incoming order 220 against all credit rules 202 and person assignments 210 stored in data store 116, then no credits are generated.

Values in credit value record 230 may be used to form a credit key of the form:

<rule_id>:<assignment_id>:<order_id>

When executing the create events processing instructions 302, 312, 322 results in the need to create data in data store 116, the create events processing instructions may be programmed to signal or programmatically call the credit lookup and appender service 115 to create entities in the data store.

Modify Events Processing Instructions

In an embodiment, the modify events processing instructions 304, 314, 324 execute according to the following algorithm or a similar algorithm.

Assume that a user modified an existing order 220 which subsequently creates an event of type MODIFY_ORDER, which is queued to the third message queue 108 based on its relationship to orders. The consumer for this event, such as order change processor 114, is programmed to evaluate the modified order against all the credit rules 202 that are stored in data store 116. The request may specify an order identifier of an order 220 that was previously appended to data store 116. However, evaluation of data representing the modified order, which is received with the request, does not cause updating the existing order 220 in the data store. Instead, evaluating the modified order may result in creating and appending one or more new credit value records 230 reflecting evaluation of applicable rules to the modified order that was received. The modify events processing instructions 324 may implement this logic.

If request specifies evaluating the order 220 based on an incentive date value, then the credit rules 220 subject to search can be filtered to include only credit rules having an effective start date and effective end date indicating validity as of the incentive date value received in the request. The rule IDs 204 of the filtered credit rules 202 then can be used to perform a lookup of credit value records 230 in the data store 116 using a pattern matching technique. An example pattern has the form:

<%:%:order_id>

The data store 116 is programmed, in response to receiving such a pattern in a search query submitted to the data store, to return in a result set all credit value records 230 that are affected by the order specified in the order ID value 222 appearing in the pattern. An order 220 can result in creating and appending more than one credit value record 230 because multiple persons may be credited via different credit rules 202. In an embodiment, the order change processor 114 is programmed to evaluate a credit value 240 of a matching credit value record 230 based on the changed order 220. The evaluation may cause creating and appending one or more new credit value records 230 in data store 116, based on the difference in the credit value 240 of a credit value record 230 that was retrieved in comparison to the newly calculated credit value.

Such a new credit value 240 of a new credit value record 230 could be positive if the modified order 220 yielded more credit than the previously generated credit. Such a new credit value 240 of a new credit value record 230 could be negative if the modified order yielded less credit value than the previously generated credit. Thus, in this approach, rather than modifying existing entities in the data store 116, a new credit value record 230 is appended and reflects a difference or delta between a previously calculated credit value and a newly calculated credit value based on applying relevant rules to the modified order. However, executing a roll-up of all credit values 240 stored in all credit value records 230 grouped by all the key entities will yield the current outstanding or total credit value.

If evaluation of rules against the modified order results in no change, then no record is appended to the data store 116. For example, an API call could specify a modified order, but the sole change might be an order type, rather than a value of the order. Depending on the configured rules, order type could have no effect on calculation of any credit. In that case, no records are appended.

In an embodiment, each credit value record 230 may include a date-time or timestamp attribute in addition to the attributes shown in FIG. 2. When credit value records 230 are timestamped, then the crediting service 20 can be programmed to receive a date value as input, query the data store 116 for all credit value records 230 having timestamp values earlier than or equal to the input date value, and generate or cause displaying a point-in-time view of the credit values 240 that existed on the specified date.

The algorithm set forth above also can be applied when a credit rule 202 or associated person assignments 210 are modified. In such an embodiment, the key patterns may comprise:

Rule Change-> <rule_id:%:%>

Assignment Change-> <%:assignment_id:%>

When executing the modify events processing instructions 304, 314, 324 results in the need to update data in data store 116, the modify events processing instructions may be programmed to signal or programmatically call the credit lookup and appender service 115 to append entities in the data store consistent with the foregoing algorithm.

Delete Event Instructions

In an embodiment, the delete events processing instructions 306, 316, 326 execute according to the following algorithm.

Assume that an administrator user deletes a credit rule 202 from the data store 116. In response, APIs 102 are programmed to create a delete event and queue the delete event to the first message queue 104 for processing using the rule change processor 110. The rule change processor 110 is programmed to create and append one or more compensating credit value records 230 in data store 116, each of the compensating credit value records having a negative value equal to the aggregated value for all the credit values 240 that had been generated prior to the delete event. Creating and appending compensating credit value records with negative credit values 240, when a sum of all relevant credit values is calculated, nullifies any previously existing credit values. Thus, aggregated sum of the credit values 240 for an order 220 will be zero.

The same approach can be applied to execute deletion of person assignments 210 or orders 220. For example, in an embodiment, when a person assignment 210 is deleted, the delete events instructions 316 are programmed to create and append a compensating negative credit in data store 116, the compensating negative credit having a credit value 240 matching a sum of all outstanding credit values for that person assignment. As another example, when an order 220 is deleted, the delete events instructions 326 are programmed to create a compensating credit value 240 for the total sum of all credit values that were previously generated for that order, thus neutralizing the credit.

When executing the delete events processing instructions 306, 316, 326 results in the need to delete data in data store 116, the delete events processing instructions may be programmed to signal or programmatically call the credit lookup and appender service 115 to append entities in the data store consistent with the foregoing algorithms.

Example Event Sequence

The foregoing description shows that while API calls, requests or messages could specify CREATE, UPDATE, or DELETE operations, and could result in queuing CREATE, UPDATE, or DELETE events to the message queues, all processing of these events for rules, person assignments, and orders always results either in appending a record to the data store 116, or no append operation, but not update operations or delete operations on the data store.

In one embodiment, crediting system 20 could be programmed to cause generating a credit value 240 based on the split percent value 216 associated with a credit rule 202 having rule ID 213 and information about the person that person ID 214 of a person assignment 210 references. At a sequence of times T1 to T5, a plurality of events having event identifiers E1 to E5 could execute as shown in TABLE 1.

TABLE 1
EXAMPLE EVENT SEQUENCE

| | Time- | | |
|---|---|---|---|
| ID | stamp | Event | Credits Generated |
| E1 | T1 | Create Rule: R1 | None |
| E2 | T2 | Create Assignment A1 | None |
| | | on R1: P1 −> 100% | |
| E3 | T3 | Create Order O1; | R1:A1:O1 => P1:100 |
| | | instructions | |
| | | execute to determine | |
| | | that O1 matches R1 | |
| E4 | T4 | Change Assignment | R1:A1:O1 => P1: (−10) |
| | | A1: P1 −> 90 | |
| E5 | T5 | Delete Assignment A1 | R1:A1:O1 => P1: (−90) |

In this example, at time T1, event E1 specifies creating rule R1. No credit values 240 are generated as a result. At time T2, event E2 creates a person assignment 210 denoted A1 and referencing a credit rule 202 denoted R1 and a person ID 214 denoted P1. No credit values 240 are generated as a result.

At time T3, event E3 is to create an order 220, denoted O1, matching the credit rule R1. In response, the instructions described above are programmed to generate a credit value 240 of “100” based on applying R1 referenced in A1 to order O1.

At time T4, event E4 is to the person assignment A1 to specify that person P1 receives a split percent of “90”. In response, the instructions described above are programmed to reevaluate credit rule R1 referenced in assignment A1 for order O1. As a result, a credit value 240 of “−10” is created and stored in data store 116. Note that the prior credit value is not updated; instead, operations always append new records to the data store 116.

At time T5, event E5 is to delete person assignment A1. In response, the instructions described above are programmed to reevaluate credit rule R1 referenced in assignment A1 for order O1. As a result, a credit value 240 of “−90” is created and stored in data store 116. Again, note that the prior credit value is not updated but new data is appended to the data store 116.

Creating and appending credit value records 230 using the foregoing algorithms enables programming instructions which, when executed, will allow users to view credit values 240 as of a certain point in time. For example, referring again to TABLE 1, if a user wishes to know the outstanding credit value 240 for order O1 at time T4, then calculating an aggregation of all the credit values for that Order O1 from T1 to T4 will yield the correct value. In an embodiment, aggregation processor 130 is programmed with executable instructions to implement the foregoing algorithm. Further, queries could request values at any of the times T1 to T5 represented in the table.

Some embodiments may be programmed to support event auditing. For example, in one embodiment, the client systems track each update to the trigger entities (Rule, Order, Person Assignment) and transmit, to the APIs 102, a version identifier of the entity associated with an update. In response, the version identifier may be stored as an attribute of a credit value record that is the target of the update. Thereafter, an auditing function may be programmed to inspect and report what change in a trigger entity caused a particular change of credit value.

In an embodiment, the aggregation processor 130 is programmed to execute trend analysis of how the total credit value is moving on a per person or per rule basis.

Real-Time Execution

In an embodiment, executing the create events processing instructions 302, 312, 322, executing the modify events processing instructions 304, 314, 324, and executing the delete events processing instructions 306, 316, 326 occurs on a real-time basis, without programmed delay or batching, in response to dequeuing calls, requests, or messages that were queued, also on a real-time basis, to the queues corresponding to those sets of instructions and the processors that execute the corresponding instructions. In practice, such real-time execution means that a call, request, or message arriving at APIs 102 is immediately queued to one of the queues, processed using one of the processors and sets of instructions, to result in invoking the credit lookup and appender service 115, to append records to the data store 116, immediately in response to the preceding operation, without programmed delays or batching. Consequently, the data store 116 is continuously updated with credit values 240 resulting from calls, queuing, execution of instructions, and calculations of credits as each individual call, request or message arrives at APIs 102, subject only to the limits of the processing hardware that executes the instructions. Therefore, the data store 116 is updated in real-time and is capable of immediate querying and use by the querying service 118 or other applications 120.

2.4 Rule Optimization by Merging and Consolidation

In an embodiment, the crediting system 20 may be programmed with merge instructions that operate to merge two or more credit rules 202 into a single new credit rule. For example, multiple credit rules 202 that are stored in data store 116, and are syntactically different but semantically the same, could be merged to reduce the total number of credit rules, thereby improving overall performance of the system. For example, assume that the following two credit rules 202 are stored in data store 116:

Rule1: ProductType=‘P1’ or Location=‘L1’->Assign SalesRep1 with a split percent of 22%

Rule2: Location=‘L1’ or ProductType=‘P1’->Assign SalesRep2 with a spit percent of 33%

Rule1 is syntactically different from Rule2, but the two rules are semantically the same. Therefore, they could be combined into one rule with both of the salesperson assignments SalesRep1, SalesRep2 included in the single rule. As a second example, one of the following two credit rules 202 uses a list of conditions using OR, and the second credit rule uses an IN operator.

Rule1: ProductType=‘P1’ and (Location=‘L1’ or Location=12′)->Assign SalesRep1 with a split percent of 22%

Rule2: ProductType=‘P1’ and (Location in (‘L1’, L2′))->Assign SalesRep2 with a spit percent of 33%

The two rules could be combined using either the OR construct or the IN construct and specifying both “Assign SalesRep1 with a split percent of 22%” and “Assign SalesRep2 with a spit percent of 33%” as result operations.

Similarly, the crediting system 20 may be programmed with aggregation processor 130 to periodically consolidate credit value records 220. In an embodiment, execution of the foregoing algorithms can result in creating and appending a large number of credit value records 230 over time. When data store 116 is storing millions of credit value records 230, the cost of processing resources necessary to execute the foregoing algorithms within a reasonable time for the user may become excessive. For example, embodiments have been tested in which participating enterprises, or customers of a SaaS implementing these techniques, have millions of orders to process against thousands of rules, resulting in millions of credit value records 230.

To avoid processing large amounts of credit value records, in an embodiment, aggregation processor 130 is programmed to periodically consolidate credit value records 220 between a particular start date/time and a particular end date/time. Consolidation may execute on-demand, according to a schedule or upon request. The data store 116 may be configured with a Production instance or set of tables, and an Archive instance or set of tables. In consolidation, the Production instance is first completely copied to the Archive instance, thereby preserving all existing credit value records 230. Then, using the Production instance, the credit values 240 of a plurality of credit value records 230 having the same key values are summed, yielding a single consolidated credit value record having the same key values but a different credit value 240. The consolidated credit value record 230 may be stored in the Production instance, and the source credit value records 230 can be deleted from the Production instance, since they have been preserved in the Archive instance. The result can be significant compacting of the Production instance. With this process, large numbers of credit value records 230 are rolled up to a single credit and the remaining credits are archived in detailed form.

Rule merge operations, and credit aggregation operations, may be implemented as discrete services that could be called asynchronously in relation to other functions of the credit service 20, or configured as cron jobs or other scheduled processes.

### 5. BENEFITS OF CERTAIN EMBODIMENTS

Embodiments provide numerous technical benefits in comparison to prior technology. As one example, the execution of operations in real time or immediately in response to a call, request, or triggering event distinguishes the approaches herein from past batch-based processing. The nature of the credit assignment process, which is dynamic and ever-changing as orders are modified, personnel changes occur, rules are updated, and person assignments change benefits from the disclosed approaches that can generate credits in real time. By “real-time,” this disclosure means that the algorithms, computing processes and calculations described herein will execute immediately in response to an API call, request, or other programmatic update to a crediting rule, person assignment, or order. Unlike prior approaches in which non real-time, batch processing is used, the algorithms, computing processes and calculations described herein execute as a continuing process to make continuing updates to a data store of credit data.

Implementing the algorithms, computing processes and calculations described herein only requires add or append operations with the data store; update and delete operations are not required. The exclusive use of append operations has been discovered to substantially increase throughput and response time by eliminating update or delete operations which are more expensive because of index update overhead, locking overhead or simply to ensure consistency depending on the database technology being used.

A separate processing job can execute aggregation of a plurality of appended credit data records. A result of such aggregation expresses or reflects the complete state of the credits. Additionally, or alternatively, the aggregation results can be written to another tablespace to result in compacting and greater efficiency later. Thus, the aggregation approach allows a new credit value to be created from the aggregated values and stored in a separate tablespace or the same tablespace, thereby reducing the total amount of credits to be processed for incentive calculation. The disclosed approaches also enable the state of credits to be viewed at a specific past point in time.

### 6. IMPLEMENTATION EXAMPLE—HARDWARE OVERVIEW

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

FIG. 5 is a block diagram that illustrates an example computer system with which an embodiment may be implemented. In the example of FIG. 5, a computer system 500 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 500 includes an input/output (I/O) subsystem 502 which may include a bus and/or other communication mechanism(s) for communicating information and/or instructions between the components of the computer system 500 over electronic signal paths. The I/O subsystem 502 may include an I/O controller, a memory controller and at least one I/O port. The electronic signal paths are represented schematically in the drawings, for example as lines, unidirectional arrows, or bidirectional arrows.

At least one hardware processor 504 is coupled to I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor or ARM processor. Processor 504 may comprise an integrated arithmetic logic unit (ALU) or may be coupled to a separate ALU.

Computer system 500 includes one or more units of memory 506, such as a main memory, which is coupled to I/O subsystem 502 for electronically digitally storing data and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, can render computer system 500 into a special-purpose machine that is customized to perform the operations specified in the instructions.

Computer system 500 further includes non-volatile memory such as read only memory (ROM) 508 or other static storage device coupled to I/O subsystem 502 for storing information and instructions for processor 504. The ROM 508 may include various forms of programmable ROM (PROM) such as erasable PROM (EPROM) or electrically erasable PROM (EEPROM). A unit of persistent storage 510 may include various forms of non-volatile RAM (NVRAM), such as FLASH memory, or solid-state storage, magnetic disk or optical disk such as CD-ROM or DVD-ROM and may be coupled to I/O subsystem 502 for storing information and instructions. Storage 510 is an example of a non-transitory computer-readable medium that may be used to store instructions and data which when executed by the processor 504 cause performing computer-implemented methods to execute the techniques herein.

The instructions in memory 506, ROM 508 or storage 510 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 500 may be coupled via I/O subsystem 502 to at least one output device 512. In one embodiment, output device 512 is a digital computer display. Examples of a display that may be used in various embodiments include a touch screen display or a light-emitting diode (LED) display or a liquid crystal display (LCD) or an e-paper display. Computer system 500 may include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators or servos.

At least one input device 514 is coupled to I/O subsystem 502 for communicating signals, data, command selections or gestures to processor 504. Examples of input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

In another embodiment, computer system 500 may comprise an internet of things (IoT) device in which one or more of the output device 512, input device 514, and control device 516 are omitted. Or, in such an embodiment, the input device 514 may comprise one or more cameras, motion detectors, thermometers, microphones, seismic detectors, other sensors or detectors, measurement devices or encoders and the output device 512 may comprise a special-purpose display such as a single-line LED or LCD display, one or more indicators, a display panel, a meter, a valve, a solenoid, an actuator or a servo.

When computer system 500 is a mobile computing device, input device 514 may comprise a global positioning system (GPS) receiver coupled to a GPS module that is capable of triangulating to a plurality of GPS satellites, determining and generating geo-location or position data such as latitude-longitude values for a geophysical location of the computer system 500. Output device 512 may include hardware, software, firmware and interfaces for generating position reporting packets, notifications, pulse or heartbeat signals, or other recurring data transmissions that specify a position of the computer system 500, alone or in combination with other application-specific data, directed toward host 524 or server 530.

Computer system 500 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 500 in response to processor 504 executing at least one sequence of at least one instruction contained in main memory 506. Such instructions may be read into main memory 506 from another storage medium, such as storage 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying at least one sequence of at least one instruction to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage 510 either before or after execution by processor 504.

Computer system 500 also includes a communication interface 518 coupled to bus 502. Communication interface 518 provides a two-way data communication coupling to network link(s) 520 that are directly or indirectly connected to at least one communication networks, such as a network 522 or a public or private cloud on the Internet. For example, communication interface 518 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 522 broadly represents a local area network (LAN), wide-area network (WAN), campus network, internetwork or any combination thereof. Communication interface 518 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 518 sends and receives electrical, electromagnetic or optical signals over signal paths that carry digital data streams representing various types of information.

Network link 520 typically provides electrical, electromagnetic, or optical data communication directly or through at least one network to other data devices, using, for example, satellite, cellular, Wi-Fi, or BLUETOOTH technology. For example, network link 520 may provide a connection through a network 522 to a host computer 524.

Furthermore, network link 520 may provide a connection through network 522 or to other computing devices via internetworking devices and/or computers that are operated by an Internet Service Provider (ISP) 526. ISP 526 provides data communication services through a world-wide packet data communication network represented as internet 528. A server computer 530 may be coupled to internet 528. Server 530 broadly represents any computer, data center, virtual machine or virtual computing instance with or without a hypervisor, or computer executing a containerized program system such as DOCKER or KUBERNETES. Server 530 may represent an electronic digital service that is implemented using more than one computer or instance and that is accessed and used by transmitting web services requests, uniform resource locator (URL) strings with parameters in HTTP payloads, API calls, app services calls, or other service calls. Computer system 500 and server 530 may form elements of a distributed computing system that includes other computers, a processing cluster, server farm or other organization of computers that cooperate to perform tasks or execute applications or services. Server 530 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 530 may comprise a web application server that hosts a presentation layer, application layer and data storage layer such as a relational database system using structured query language (SQL) or no SQL, an object store, a graph database, a flat file system or other data storage.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage 510, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 504. While each processor 504 or core of the processor executes a single task at a time, computer system 500 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 7. EXTENSIONS AND ALTERNATIVES

In the foregoing specification, embodiments of the invention have been described with reference to numerous specific details that may vary from implementation to implementation. Thus, the sole and exclusive indicator of what is the invention and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer-implemented method of calculating credit values in incentive-based compensation systems and updating a data store of digitally stored credit values, the method comprising:
creating and digitally storing, in an electronic digital data store, over a million credit rule records comprising rule expressions for calculating credit values, over a million person assignment records that associate credit rule records with person records, and over a million order records, the order records each comprising an association of an order identifier with at least an order amount;
receiving a request to execute a change of a credit rule, person assignment, or order;
in real time in response to the request, executing stored program instructions that are programmed to, in response to a request to execute the change of the credit rule:
evaluate the credit rule against all orders then currently stored in the data store to determine a result set of matching orders, and
digitally append in the data store one or more credit value records each comprising a credit value, each credit value being calculated based on a rule expression of the credit rule, each credit value record being digitally linked to an order identifier of one of the matching orders, to the person assignment, and to the credit rule;
repeating the receiving and executing steps, in which execution of the evaluate and determine step always causes to digitally append the one or more credit value records in the data store and not to delete credit value records in the data store and not to update existing credit value records in the data store.

2. The method of claim 1, further comprising, in real time in response to the request, executing stored program instructions that are programmed to, in response to a request to execute the change of the order: evaluate the order against all credit rules then currently stored in the data store, determine a result set of matching credit rules, and digitally append in the data store a credit value record comprising a credit value that is calculated based on a rule expression of the credit rule, and that is linked to the order identifier, the person assignment, and the credit rule.

3. The method of claim 2, further comprising calculating the credit value of a particular matched credit rule by evaluating the rule expression and digitally applying a split percent value of each person assignment having a rule identifier that matches the particular matched credit rule.

4. The method of claim 2, the request comprising an incentive date value, further comprising:
filtering the credit rules that are stored in the data store to include only credit rules having an effective start date and effective end date indicating validity as of the incentive date value, to yield a set of filtered credit rules;
performing a lookup of credit value records in the data store that match the filtered credit rules, to yield a set of selected credit value records;
evaluating the order against the filtered credit rules then currently stored in the data store, determine a result set of matching credit rules, and calculate one or more new credit values based on applying the order to rule expressions of the filtered credit rules;
digitally appending in the data store one or more new credit value records each comprising a credit value that is calculated based on a difference in credit values of the selected credit value records in comparison to the new credit values.

5. The method of claim 1, further comprising, in real time in response to the request, executing stored program instructions that are programmed to, in response to a request to execute a deletion of a particular credit rule, create and append one or more compensating credit value records in the data store, each of the compensating credit value records having a negative value equal to a sum of all credit values that had been appended prior to the request and linked to the particular credit rule.

6. The method of claim 5, further comprising receiving a request to display an aggregated credit value for a specified set of events or a specified period of time and, in real time in response to the request, calculating a sum of all credit values including compensating credit value records with negative credit values, and outputting the sum as an aggregated value.

7. The method of claim 1, further comprising, in real time in response to a request to delete a particular person assignment, executing stored program instructions that are programmed to:
create and append a compensating credit value record in the data store, the compensating credit value record comprising a compensating negative credit value, the compensating negative credit value being equal to a sum of all credit values then currently existing in the data store that are linked to the particular person assignment.

8. The method of claim 1, further comprising, in real time in response to a request to delete a particular order, executing stored program instructions that are programmed to:
create and append a compensating credit value record in the data store, the compensating credit value record comprising a compensating negative credit value, the compensating negative credit value being equal to a sum of all credit values then currently existing in the data store that are linked to the particular order.

9. The method of claim 1, each of the plurality of credit rule records further comprising a rule identifier that is digitally linked to a person assignment and to at least one credit value record.

10. The method of claim 1, each of the plurality of person assignment records comprising an assignment identifier that is digitally linked to at least one credit value record, a person identifier, a split percent value, and a rule identifier that is digitally linked to one of the credit rule records.

11. The method of claim 1, the order identifier in each of the plurality of order records being digitally linked to at least one of the credit value records.

12. The method of claim 1, each of the credit value records having a key value comprising a combination of a rule identifier of a credit rule record, an assignment identifier of a person assignment record, and an order identifier of an order record.

13. A computer system comprising:
one or more hardware processors organized as a processing service and coupled to one or more computer networks;
an electronic digital data store coupled to the one or more hardware processors via the one or more computer networks;
one or more non-transitory digital data storage media storing one or more sequences of stored program instructions which, when executed using the one or more hardware processors, cause the one or more hardware processors to execute a process of calculating credit values in incentive-based compensation systems and updating a data store of digitally stored credit values via process steps comprising:
creating and digitally storing, in the electronic digital data store, over a million credit rule records comprising rule expressions for calculating credit values, over a million person assignment records that associate credit rule records with person records, and over a million order records, the order records each comprising an association of an order identifier with at least an order amount;
receiving a request to execute a change of a credit rule, person assignment, or order;
in real time in response to the request, executing stored program instructions that are programmed to, in response to a request to execute the change of the credit rule:
evaluate the credit rule against all orders then currently stored in the data store to determine a result set of matching orders, and
digitally append in the data store one or more credit value records each comprising a credit value, each credit value being calculated based on a rule expression of the credit rule, each credit value record being digitally linked to an order identifier of one of the matching orders, to the person assignment, and to the credit rule;
repeating the receiving and executing steps, in which execution of the evaluate and determine step always causes to digitally append the one or more credit value records in the data store and not to delete credit value records in the data store and not to update existing credit value records in the data store.

14. The computer system of claim 13, further comprising sequences of instructions which when executed using the one or more hardware processors cause executing, in real time in response to the request, executing stored program instructions that are programmed to, in response to a request to execute the change of the order: evaluate the order against all credit rules then currently stored in the data store, determine a result set of matching credit rules, and digitally append in the data store a credit value record comprising a credit value that is calculated based on a rule expression of the credit rule, and that is linked to the order identifier, the person assignment, and the credit rule.

15. The computer system of claim 14, further comprising sequences of instructions which when executed using the one or more hardware processors cause calculating the credit value of a particular matched credit rule by evaluating the rule expression and digitally applying a split percent value of each person assignment having a rule identifier that matches the particular matched credit rule.

16. The computer system of claim 14, the request comprising an incentive date value, further comprising sequences of instructions which when executed using the one or more hardware processors cause executing:
filtering the credit rules that are stored in the data store to include only credit rules having an effective start date and effective end date indicating validity as of the incentive date value, to yield a set of filtered credit rules;
performing a lookup of credit value records in the data store that match the filtered credit rules, to yield a set of selected credit value records;
evaluating the order against the filtered credit rules then currently stored in the data store, determine a result set of matching credit rules, and calculate one or more new credit values based on applying the order to rule expressions of the filtered credit rules;
digitally appending in the data store one or more new credit value records each comprising a credit value that is calculated based on a difference in credit values of the selected credit value records in comparison to the new credit values.

17. The computer system of claim 13, further comprising sequences of instructions which when executed using the one or more hardware processors cause executing, in real time in response to the request, executing stored program instructions that are programmed to, in response to a request to execute a deletion of a particular credit rule, create and append one or more compensating credit value records in the data store, each of the compensating credit value records having a negative value equal to a sum of all credit values that had been appended prior to the request and linked to the particular credit rule.

18. The computer system of claim 17, further comprising sequences of instructions which when executed using the one or more hardware processors cause receiving a request to display an aggregated credit value for a specified set of events or a specified period of time and, in real time in response to the request, calculating a sum of all credit values including compensating credit value records with negative credit values, and outputting the sum as an aggregated value.

19. The computer system of claim 13, further comprising sequences of instructions which when executed using the one or more hardware processors cause executing, in real time in response to a request to delete a particular person assignment, executing stored program instructions that are programmed to:
create and append a compensating credit value record in the data store, the compensating credit value record comprising a compensating negative credit value, the compensating negative credit value being equal to a sum of all credit values then currently existing in the data store that are linked to the particular person assignment.

20. The computer system of claim 13, further comprising sequences of instructions which when executed using the one or more hardware processors cause executing, in real time in response to a request to delete a particular order, executing stored program instructions that are programmed to:
create and append a compensating credit value record in the data store, the compensating credit value record comprising a compensating negative credit value, the compensating negative credit value being equal to a sum of all credit values then currently existing in the data store that are linked to the particular order.
